(19) United States
(12) Patent Application Publication
(10) Pub. No.: US 2013/0100120 A1
(43) Pub. Date: Apr. 25, 2013

(54) 3D IMAGE DISPLAY DEVICES

(71) Applicant: Naoki SUMI, Chu-Nan (TW)

(72) Inventor: Naoki SUMI, Chu-Nan (TW)

(73) Assignee: CHIMEI INNOLUX CORPORATION, Chu-Nan (TW)

(21) Appl. No.: 13/281,388

(22) Filed: Oct. 25, 2011

(51) Int. Cl. G06T 15/00

(52) U.S. Cl. 345/419

(57) ABSTRACT

Disclosed is a 3D image display device, including an image display device and a 3D device such as lenticular lens layer (or 3D barrier) thereon. The image display device includes right eye pixels and left eye pixels having a same width W₃. Each of the lenses lenticular lenses substantially aligns with one right eye pixel and one left eye pixel. Alternately, the 3D barrier includes openings disposed between the light barriers, and the openings substantially align with interfaces of the right eye pixels and the left eye pixels. A top of the lenticular lenses (or 3D barrier) and a top of the pixel layer have an optical distance in air D₃ therebetween. The width W₃ and the optical distance in air D₃ have a ratio of 1:Y, where Y is smaller than 4.1.

### BACKGROUND OF THE INVENTION

1. Field of the Invention

The disclosure relates to 3D image display devices, and in particular relates to a defocused center pitch or a 3D aperture pitch.

2. Description of the Related Art

A 3D image display device of the lenticular lens type may show 3D images as shown in FIG. 1A. An image display device, e.g. LCD, includes an array substrate 11, a color filter substrate 13, and a liquid crystal layer 14 disposed therebetween. A plurality of right eye pixels 12R and left eye pixels 12L are alternately arranged to construct a pixel layer 12 on the array substrate 11. A polarizer 15, a glue layer 17, a PET film 19, and a lenticular lens layer 21 having a plurality lenses are sequentially disposed on the color filter substrate 13. Each of the lenses of the lenticular lens layer 21 substantially aligns with one right eye pixel 12R and one left eye pixel 12L. As shown in FIG. 1A, a right eye R of a viewer sees right eye images from the right eye pixels 12R through the lenticular lens layer 21, and a left eye L of the viewer sees left eye images from the left eye pixels 12L through the lenticular lens layer 21, respectively. The right eye R will see defocused areas 23R on the right eye pixels 12R, and the left eye L will see the other defocused areas 23L on the left eye pixels 12L. The right eye images and the left eye images are combined in the brain of the viewer to see 3D images.

FIG. 1B shows the top view of the right eye pixel and the left eye pixel in FIG. 1A. The right eye pixel 12R includes a top part as a red pixel, a middle part as a green pixel, and a bottom part as a blue pixel. Similarly, the left eye pixel 12L includes a top part as a red pixel, a middle part as a green pixel, and a bottom part as a blue pixel. Each of the red, green, and blue pixels includes a control element 25 such as TFT and/or storage capacitance to control the brightness thereof. The right eye pixel 12R and the left eye pixel 12L have a same width W₁. A defocused area 23R center on the right eye pixel 12R and another defocused area 23L center on the left eye pixel 12L have a defocused center pitch P₁ therebetween. As shown in FIG. 1B, the defocused center pitch P₁ is equal to the width W₁ of the right eye pixel or the left eye pixel.

FIG. 1C shows view image types and their region maps of the 3D image display in FIG. 1A for a viewer in different positions. The 3D image display device 27 of FIG. 1A is located at the bottom center of FIG. 1C. In FIG. 1C, the x-position means a horizontal distance between the viewer and the 3D image display device 27, and the z-position means a vertical distance between the viewer and the 3D image display device 27. A viewer may see 2D right eye images in a right eye image region composed of the slash lines shown in FIG. 1C, wherein 2D left eye images can be seen in a left eye image region composed of the backslash lines shown in FIG. 1C, and 3D images in a 3D image region can be seen as being composed of grids as shown in FIG. 1C. In other positions in FIG. 1C, the viewer may see 2D left eye images from the right eye, and see 2D right eye images from the left eye, wherein the 2D right eye images and the 2D left eye images seen from the unintended eyes combine in the brain for pseudo 3D image viewing. As shown in FIG. 1C, the viewer easily sees pseudo 3D images due to the narrow 2D right eye image region and the narrow 2D left eye image region.

The narrow 2D right eye image region and 2D left eye image region do not only occur in the 3D image display device of the lenticular lens type, but also occurs in the 3D image display device of the barrier type. A 3D image display device of the barrier type may show 3D images as shown in FIG. 2A. An image display device, e.g. LCD, includes an array substrate 11, a color filter substrate 13, and a liquid crystal layer 14 disposed therebetween. A plurality of right eye pixels 12R and left eye pixels 12L are alternately arranged to construct a pixel layer 12 on the array substrate 11. A polarizer 15, a glue layer 17, a glass layer 19, and a 3D barrier 29 are sequentially disposed on the color filter substrate 13. The 3D barrier 29 includes openings 29A disposed between the light barriers 29B, and the openings 29A substantially align with interfaces of the right eye pixels 12R and the left eye pixels 12L. As shown in FIG. 2A, a right eye of a viewer sees right eye images from the right eye pixels 12R through the openings 29A of the 3D barrier 29, and a left eye of the viewer sees left eye images from the left eye pixels 12L through the openings 29A of the 3D barrier 29, respectively. The right eye R will see 3D aperture areas 30R on the right eye pixels 12R, and the left eye L will see the other 3D aperture areas 30L on the left eye pixels 12L. The right eye images and the left eye images will be combined in the brain of the viewer to see 3D images.

FIG. 2B shows the top view of the right eye pixel and the left eye pixel of FIG. 2A. The right eye pixel 12R includes a top part as a red pixel, a middle part as a green pixel, and a bottom part as a blue pixel. Similarly, the left eye pixel 12L includes a top part as a red pixel, a middle part as a green pixel, and a bottom part as a blue pixel. Each of the red, green, and blue pixels includes a control element 25 such as TFT and/or storage capacitance (Cs) to control the brightness thereof. The right eye pixel 12R and the left eye pixel 12L have a same width W₁. A 3D aperture area 30R center on the right eye pixel 12R and another 3D aperture area 30L center on the left eye pixel 12L have a 3D aperture pitch P₂ therebetween. As shown in FIG. 2B, the 3D aperture pitch P₂ is equal to the width W₁ of the right eye pixel or the left eye pixel. When the W₁/P₂ ratio is equal to 1, the 2D right eye image region will almost overlaps with the 2D left eye image region, such that the viewer will easily see pseudo 3D images.

The pseudo 3D images cause a viewer to be dizzy or even have headaches. A novel design of the 3D image display device which has a larger 2D right eye image region, a larger 2D left eye image region, and a larger 3D image region to prevent a viewer from seeing pseudo 3D images is called for.

### BRIEF SUMMARY OF THE INVENTION

One embodiment of the disclosure provides a 3D image display device, comprising: an image display device including a pixel layer having a plurality of right eye pixels and a plurality of left eye pixels; and a 3D device disposed on the image display device, wherein each of right eye pixel and each of the left eye pixel having a substantially same width, wherein the 3D device and the pixel layer have an optical distance in air therebetween, and wherein the width and the optical distance in air have a ratio of 1:Y, where Y is smaller than 4.1.

One embodiment of the disclosure provides a method of displaying a 3D image, comprising: providing the described 3D image display device for a viewer; and displaying a right eye image from the right eye pixel to a right eye of the viewer through the 3D device, and displaying a left eye image from the left eye pixel to a left eye of the viewer through the 3D device, respectively, wherein the right eye sees a first area on the right eye pixel, and the left eye sees a second area on the left eye pixel, wherein the first and second areas have a center pitch therebetween, and wherein the center pitch is shorter than the right eye and left eye pixel width.

A detailed description is given in the following embodiments with reference to the accompanying drawings.

### BRIEF DESCRIPTION OF THE DRAWINGS

The present disclosure can be more fully understood by reading the subsequent detailed description and examples with references made to the accompanying drawings, wherein:

FIG. 1A is a cross section of a lenticular lens type 3D image display device in related art;

FIG. 1B shows the top view of the right eye pixel and the left eye pixel in FIG. 1A;

FIG. 1C shows view image types and their region maps of the 3D image display in FIG. 1A for a viewer in different positions;

FIG. 2A is a cross section of a barrier type 3D image display device in related art;

FIG. 2B shows the top view of the right eye pixel and the left eye pixel in FIG. 2A;

FIG. 3A is a cross section of a lenticular lens type 3D image display device in one embodiment of the disclosure;

FIG. 3B shows the top view of the right eye pixel and the left eye pixel in FIG. 3A;

FIG. 3C shows view image types and their region maps of the 3D image display in FIG. 3A for a viewer in different positions;

FIGS. 4A-4D show top views of the defocused regions on the left eye pixels and the right eye pixels;

FIGS. 5A-5D show view image types and their region maps of the 3D image display devices in FIGS. 4A-4D for a viewer in different positions;

FIG. 6A is a cross section of a barrier type 3D image display device in one embodiment of the disclosure;

FIG. 6B shows the top view of the right eye pixel and the left eye pixel in FIG. 6A; and

FIG. 7 shows view image types and their region maps of 3D image display devices having different W₃/P₄ ratios for a viewer in different positions.

### DETAILED DESCRIPTION OF THE INVENTION

The following description is of the best-contemplated mode of carrying out the disclosure. This description is made for the purpose of illustrating the general principles of the disclosure and should not be taken in a limiting sense. The scope of the disclosure is best determined by reference to the appended claims.

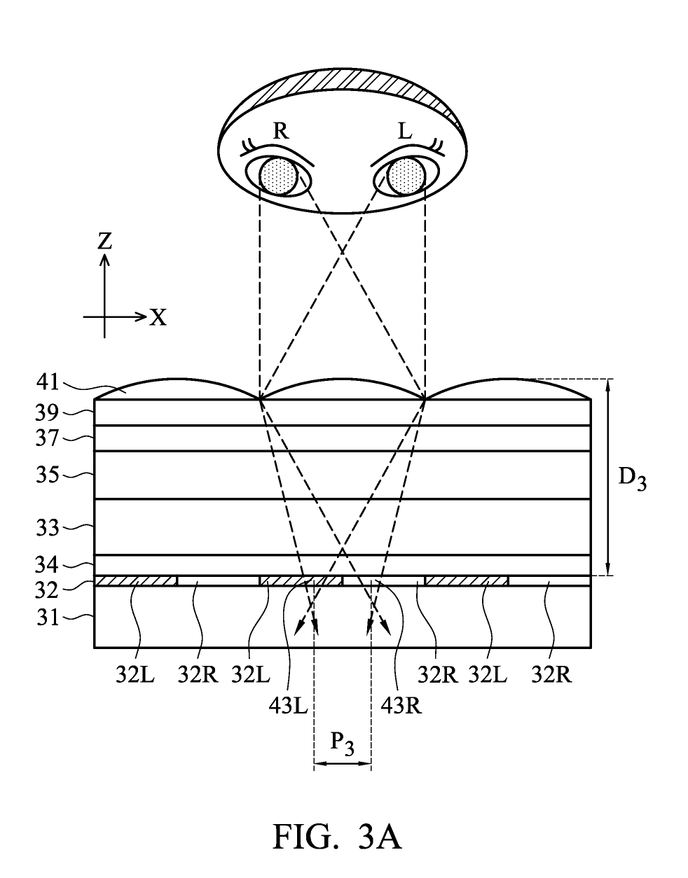

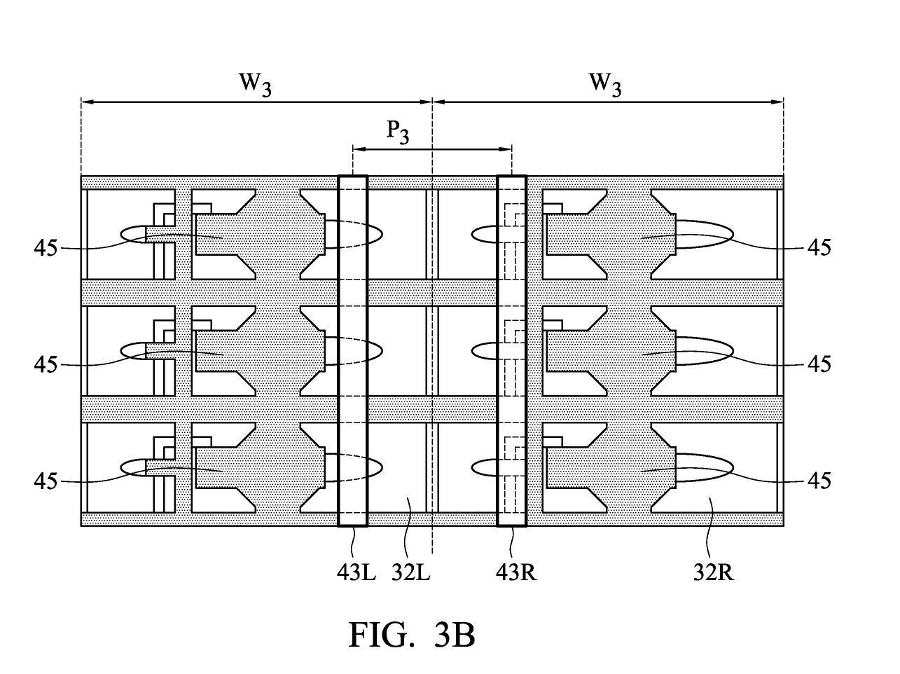

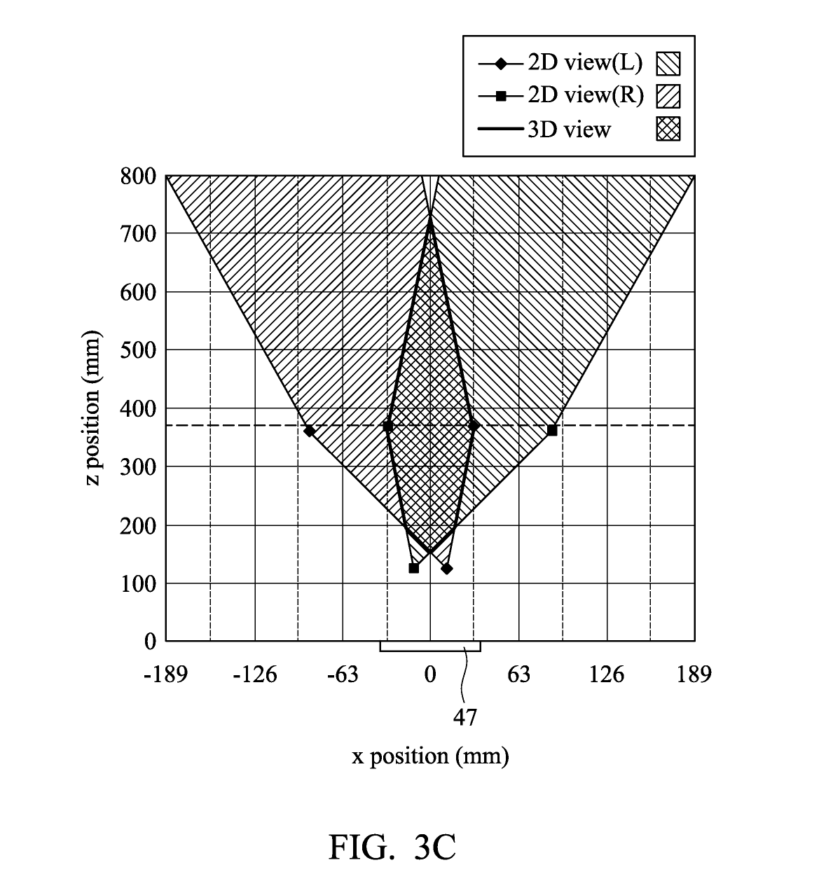

FIG. 3A shows a lenticular lens type 3D image display device in one embodiment of the disclosure. An image display device, e.g. LCD, includes an array substrate 31, a color filter substrate 33, and a liquid crystal layer 34 disposed therebetween. A plurality of right eye pixels 32R and left eye pixels 32L are alternately arranged to construct a pixel layer 32 on the array substrate 31. A polarizer 35, a glue layer 37, a PET layer 39, and a 3D device such as lenticular lens layer 41 having a plurality of lenses are sequentially disposed on the color filter substrate 33. A top of the lenticular lens layer 41 and a top of the pixel layer 32 have an optical distance in air D₃ therebetween. An optical distance in air is defined by sum of each layer thickness divided by each layer's refractive index. Each of the lenses of the lenticular lens layer 41 substantially aligns with one right eye pixel 32R and one left eye pixel 32L. As shown in FIG. 3A, a right eye of a viewer sees right eye images from the right eye pixels 32R through the lenticular lens layer 41, and a left eye of the viewer sees left eye images from the left eye pixels 32L through the lenticular lens layer 41, respectively. The right eye R will see defocused areas 43R on the right eye pixels 32R, and the left eye L will see the other 3D aperture areas 43L on the left eye pixels 32L. The right eye images and the left eye images will be combined in the brain of the viewer to see 3D images. Note that the image display device includes, but is not limited to, the LCD as shown in FIG. 3A. For example, the image display device can be an electronic paper, an electronic reader, electroluminescent display (ELD), organic electroluminescent display (OELD), vacuum fluorescent display (VFD), light emitting diode display (LED), cathode ray tube (CRT), liquid crystal display (LCD), plasma display panel (PDP), digital light processing (DLP) display, liquid crystal on silicon (LCoS), organic light-emitting diode (OLED), surface-conduction electron-emitter display (SED), field emission display (FED), laser TV (Quantum dot laser; Liquid crystal laser), Ferro liquid display (FLD), interferometer modulator display (iMoD), thick-film dielectric electroluminescent (TDEL), quantum dot display (QD-LED), telescopic pixel display (TPD), organic light-emitting transistor (OLET), electrochromic display, laser phosphor display (LPD), or the like. It is understood that the liquid crystal layer 34 can be omitted in other image display devices. Also note that the lenticular lens layer 41 is not limited to only the fixed type lenticular lens layer, but also a switchable lenticular lens cell that comprise two glasses, liquid crystal, polarizer and other components.

FIG. 3B shows the top view of the right eye pixel and the left eye pixel in FIG. 3A. The right eye pixel 32R includes a top part as a red pixel, a middle part as a green pixel, and a bottom part as a blue pixel. Similarly, the left eye pixel 32L includes a top part as a red pixel, a middle part as a green pixel, and a bottom part as a blue pixel. Each of the red, green, and blue pixels includes a control element 45 such as TFT and/or storage capacitance (Cs) to control the brightness thereof. The right eye pixel 32R and the left eye pixel 32L have a same width W₃. A defocused area 43R center on the right eye pixel 32R and another defocused area 43L center on the left eye pixel 32L have a defocused center pitch P₃ therebetween. As shown in FIG. 3B, the width W₃ of the right eye pixel 32R (or the left eye pixel 32L) and the defocused center pitch P₃ have a ratio of 100:50.

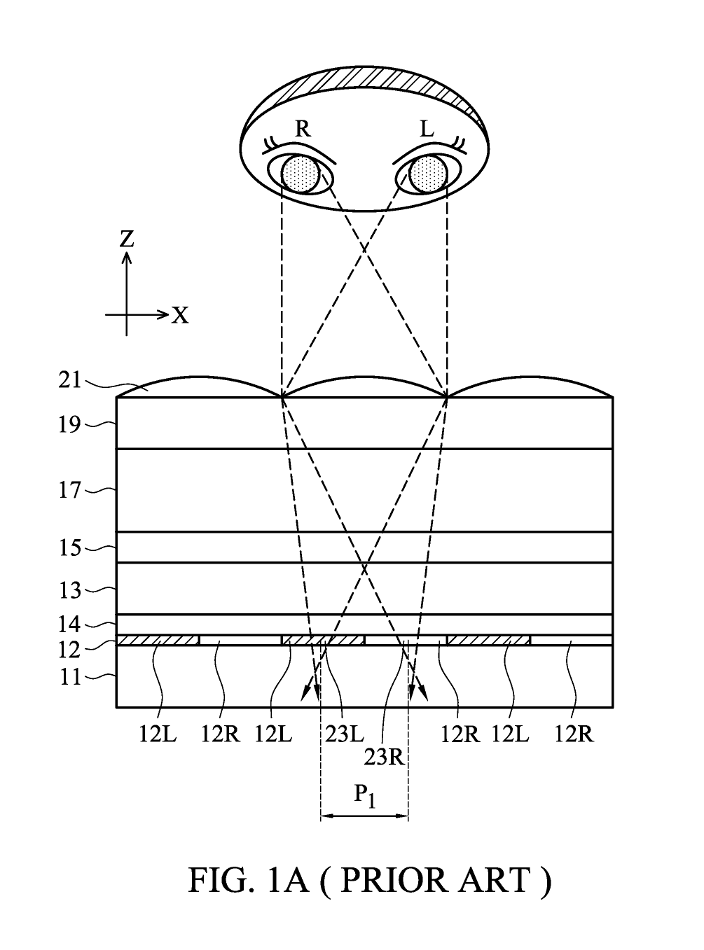

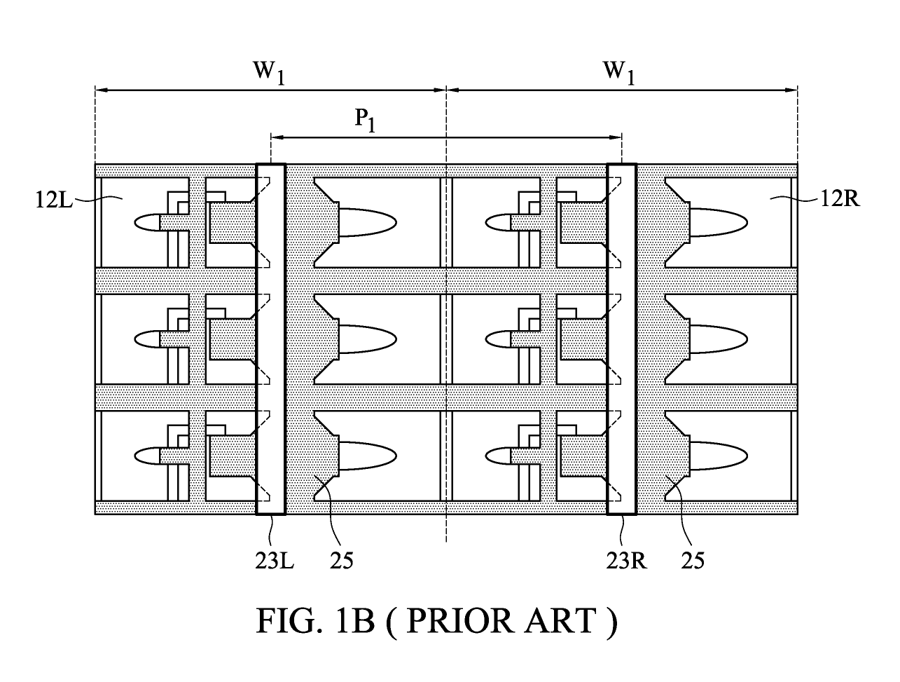

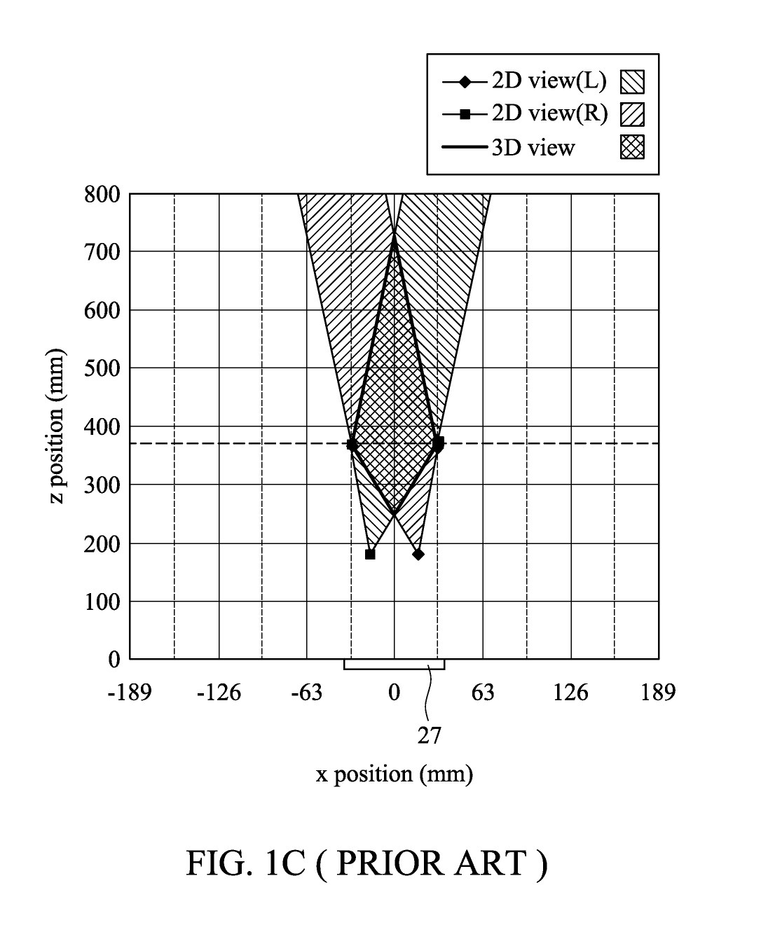

FIG. 3C shows view image types and their region maps of the 3D image display device in FIG. 3A for a viewer in different positions. The 3D image display device 47 of FIG. 3A is located in bottom center of FIG. 3C. In FIG. 3C, the x-position means a horizontal distance between the viewer and the 3D image display device 47, and the z-position means a vertical distance between the viewer and the 3D image display device 47. A viewer may see 2D right eye images in a right eye image region composed of slash lines as shown in FIG. 3C. 2D left eye images may be seen in a left eye image region composed of the backslash lines shown in FIG. 3C. 3D images may be seen in a 3D image region composed of grids as shown in FIG. 3C. In other positions in FIG. 3C, the viewer may see 2D left eye images from the right eye, see 2D right eye images from the left eye, and the 2D right eye images and the 2D left eye images from the unintended eyes will combine in the brain to complete pseudo 3D images. Because the ratio of W₃ to P₃ is larger in FIGS. 3A-3B than the ratio of W₁ to P₁ in FIGS. 1A-1B, the 2D right eye image region and the 2D left eye image region in FIG. 3C are much larger than that in FIG. 1C. As such, the viewer in FIG. 3C will not see pseudo 3D images as easy as shown in FIG. 1C. Moreover, the 3D image region in FIG. 3C is also larger than that in FIG. 1C.

Accordingly, when the defocused center pitch P₃ is shorter and/or the width W₃ of the right eye pixel 32R (or the left eye pixel 32L) is longer, the pseudo 3D image region will be reduced and the 2D/3D image regions will be increased. In one embodiment, the width W₃ and the defocused center pitch P₃ have a ratio of 100:X, where X is smaller than 85. An overly high W₃/P₃ ratio may be difficult in the mass production due to a thinner film and glass requirement, and an overly low W₃/P₃ ratio may not effectively enlarge 2D and 3D image region. Note that the ratio of width W₃ to defocused center pitch P₃ can be controlled by the ratio between the width W₃, and the optical distance in air D₃ (see FIG. 3A). The longer the optical distance in air D₃ is, the longer the defocused center pitch P₃ may be, and the shorter the optical distance in air D₃ is, the shorter the defocused center pitch P₃ may be. In one embodiment, the width W₃ and the optical distance in air D₃ have a ratio of 1:Y, where Y is smaller than 4.1. When the width W₃ is a constant, an overly long optical distance in air D₃ may not effectively enlarge 2D and 3D image region, and an overly short optical distance in air D₃ may be difficult in the mass production due to a thinner film and glass requirement. A curvature radius of the lenticular lens layer 41 can be adjusted to get a proper focusing on the pixel layer 32. But the value of the radius is not limited on the purpose of the embodiment.

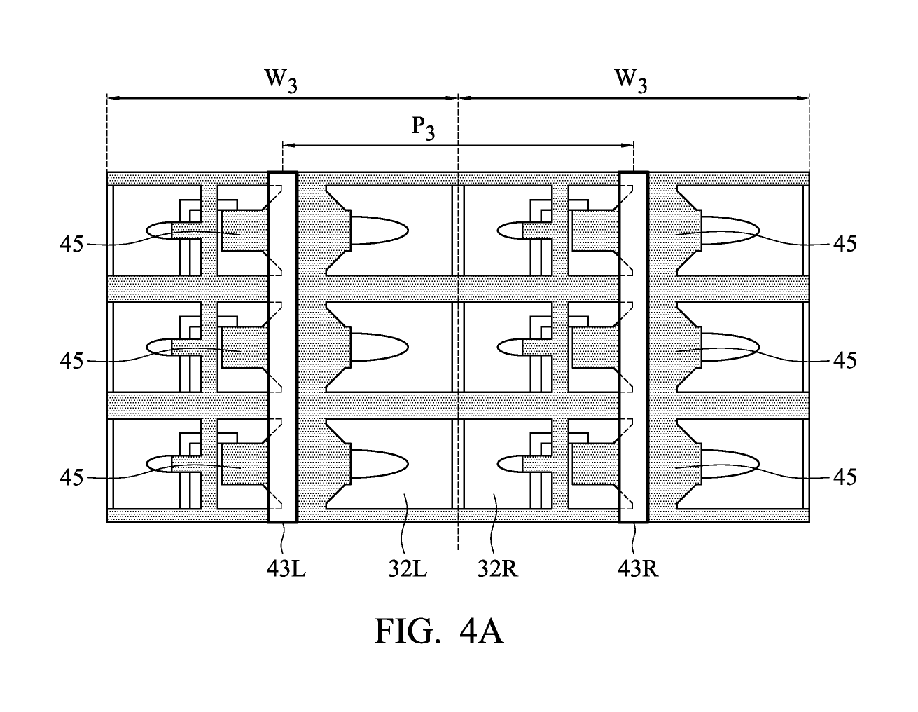

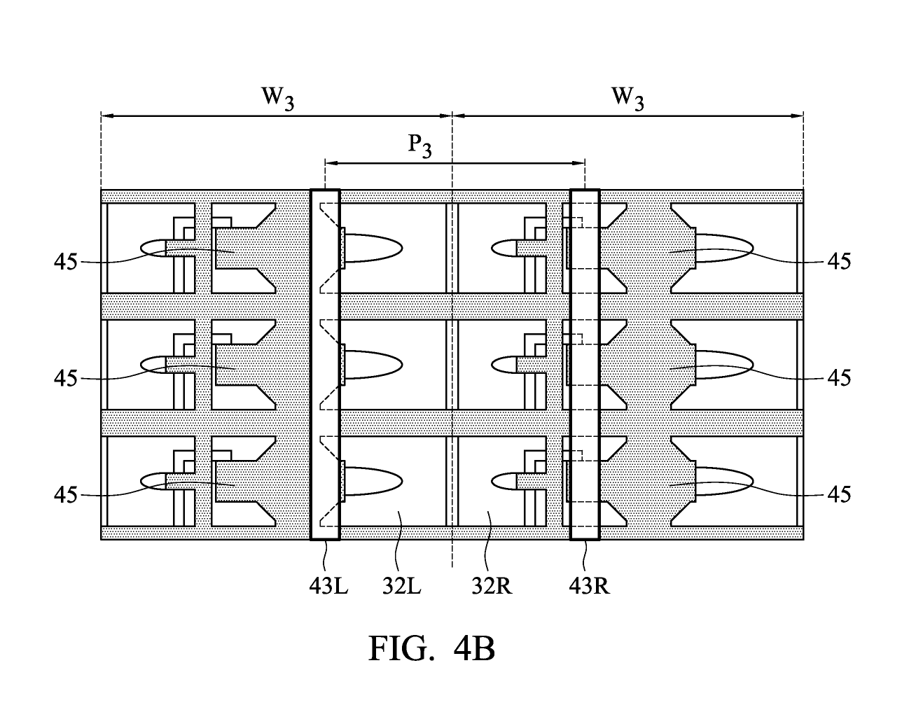

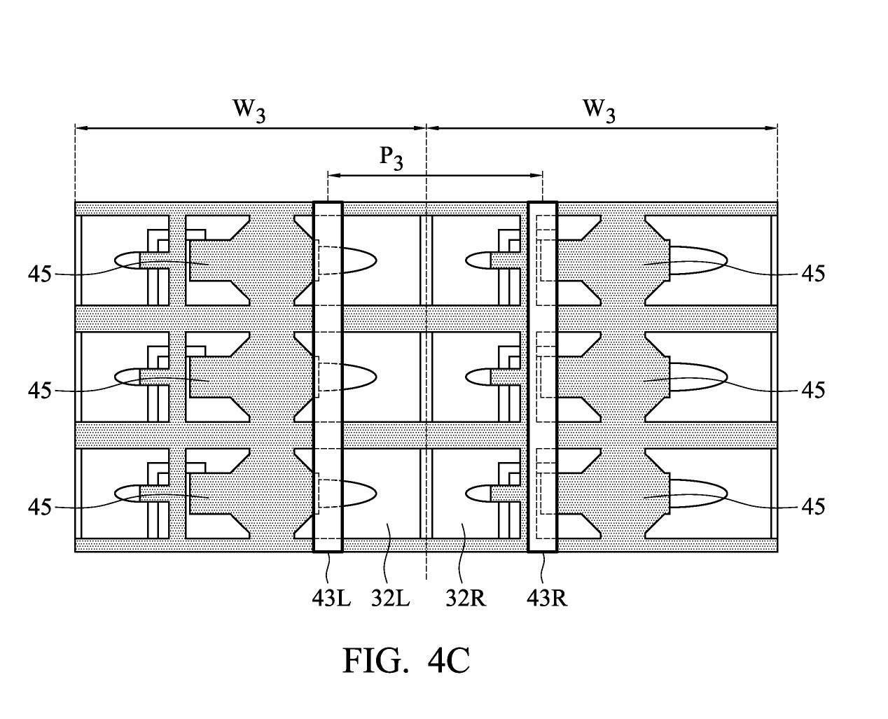

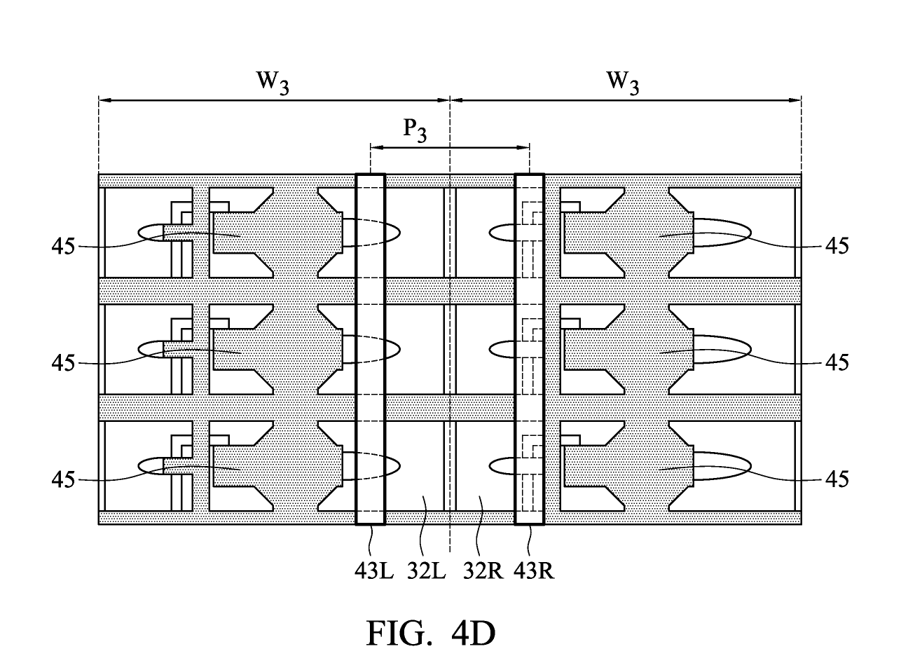

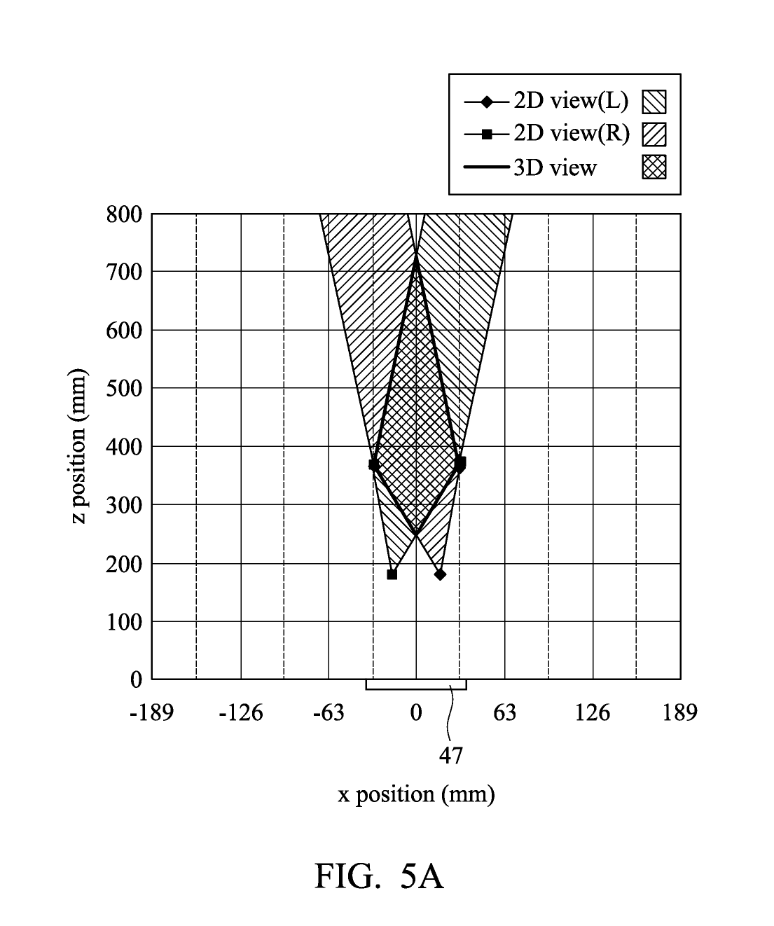

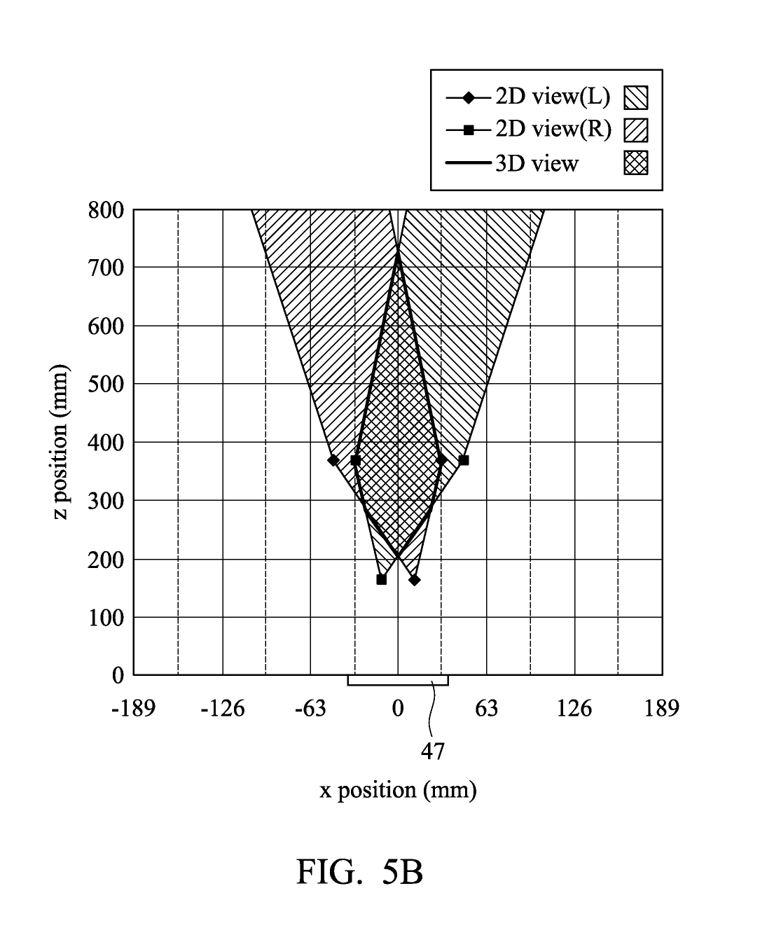

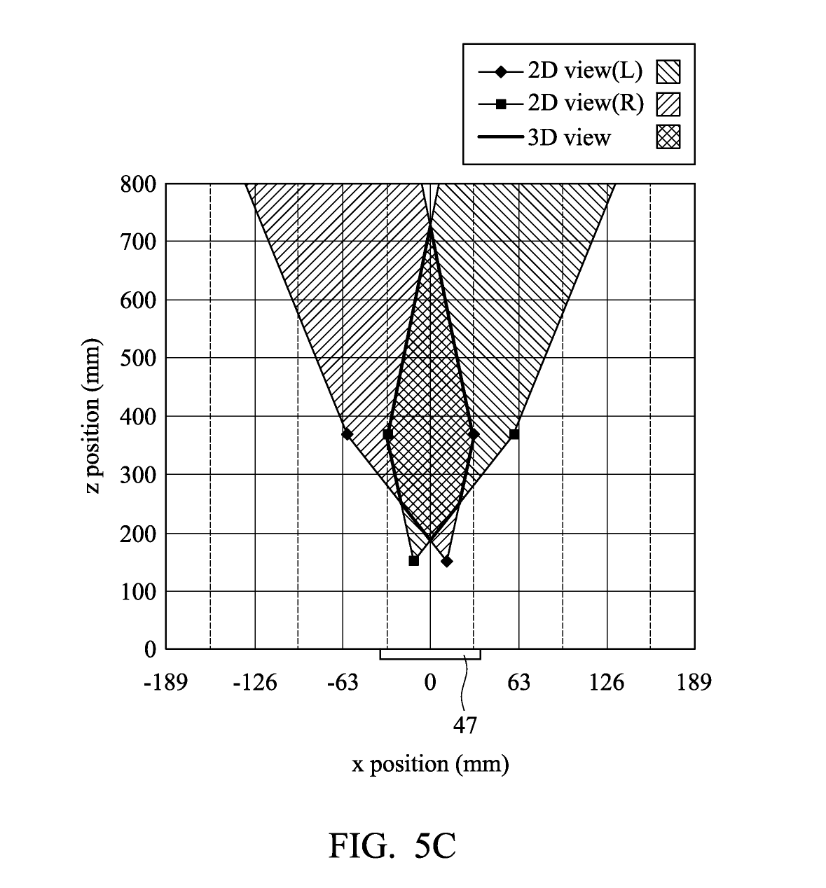

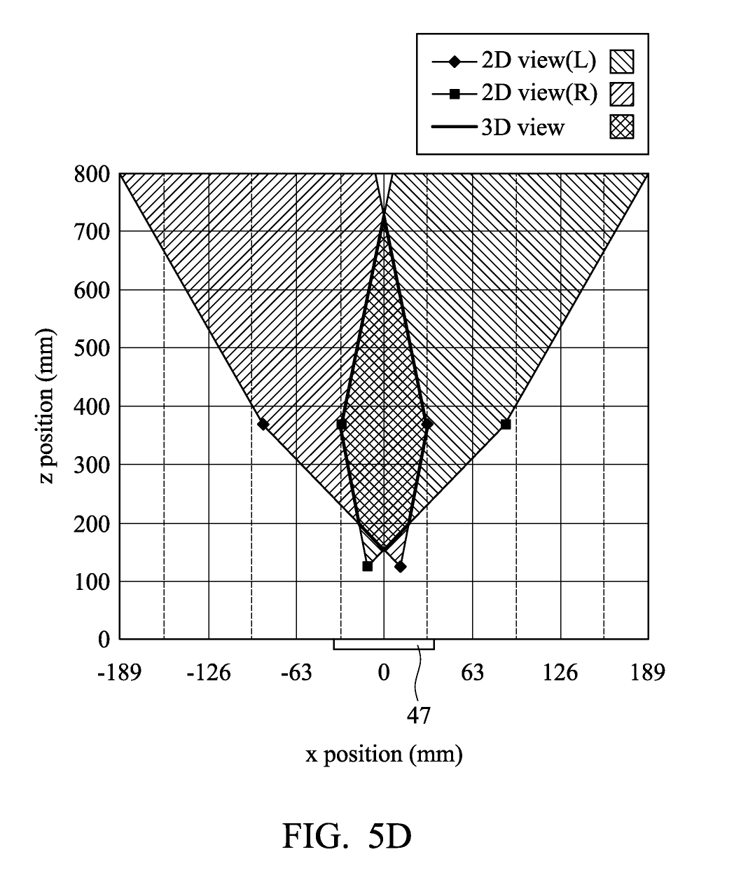

FIGS. 4A-4D are top views of the defocused regions on the left eye pixels and the right eye pixels. FIGS. 5A-5D show view image types and their region maps of the 3D image display devices in FIGS. 4A-4D for a viewer in different positions, respectively. The 3D image display device 47 is located at the bottom center of the FIGS. 5A-5D, respectively. In FIGS. 5A-5D, the x-position means a horizontal distance between the viewer and the 3D image display device 47, and the z-position means a vertical distance between the viewer and the 3D image display device 47. In one embodiment, the width W₃ of the right eye pixel 32R (or the left eye pixel 32L) is about 94.5 μm, the optical distance in air D₃ is 559 μm, the curvature radius of the lenses of the lenticular lens layer 41 is 315 μm, and the width W₃ of the of the right eye pixel 32R (or the left eye pixel 32L) and the defocused center pitch P₃ have a ratio of 100:100 as shown in FIG. 4A, such that the 2D right eye image region, the 2D left eye image region, and the 3D image region is narrow as shown in FIG. 5A.

In one embodiment, the width W₃ of the right eye pixel 32R (or the left eye pixel 32L) is about 94.5 μm, the optical distance in air D₃ is 445 μm, the curvature radius of the lenses of the lenticular lens layer 41 is 255 μm, and the width W₃ of the of the right eye pixel 32R (or the left eye pixel 32L) and the defocused center pitch P₃ have a ratio of 100:80 as shown in FIG. 4B, such that the 2D right eye image region, the 2D left eye image region, and the 3D image region is larger in FIG. 5B than that in FIG. 5A.

In one embodiment, the width W₃ of the right eye pixel 32R (or the left eye pixel 32L) is about 94.5 μm, the optical distance in air D₃ is 384 μm, the curvature radius of the lenses of the lenticular lens layer 41 is 225 μm, and the width W₃ of the of the right eye pixel 32R (or the left eye pixel 32L) and the defocused center pitch P₃ have a ratio of 100:66 as shown in FIG. 4C, such that the 2D right eye image region, the 2D left eye image region, and the 3D image region is larger in FIG. 5C than that in FIGS. 5A and 5B.

In one embodiment, the width W₃ of the right eye pixel 32R (or the left eye pixel 32L) is about 94.5 μm, the optical distance in air D₃ is 296 μm, the curvature radius of the lenses of the lenticular lens layer 41 is 180 μm, and the width W₃ of the of the right eye pixel 32R (or the left eye pixel 32L) and the defocused center pitch P₃ have a ratio of 100:50 as shown in FIG. 4D, such that the 2D right eye image region, the 2D left eye image region, and the 3D image region is larger in FIG. 5D than that in FIGS. 5A, 5B, and 5C. In other words, the 3D image display device with a higher W₃/P₃ ratio will have a larger 2D right eye image region, a larger 2D left eye image region, and a larger 3D image region.

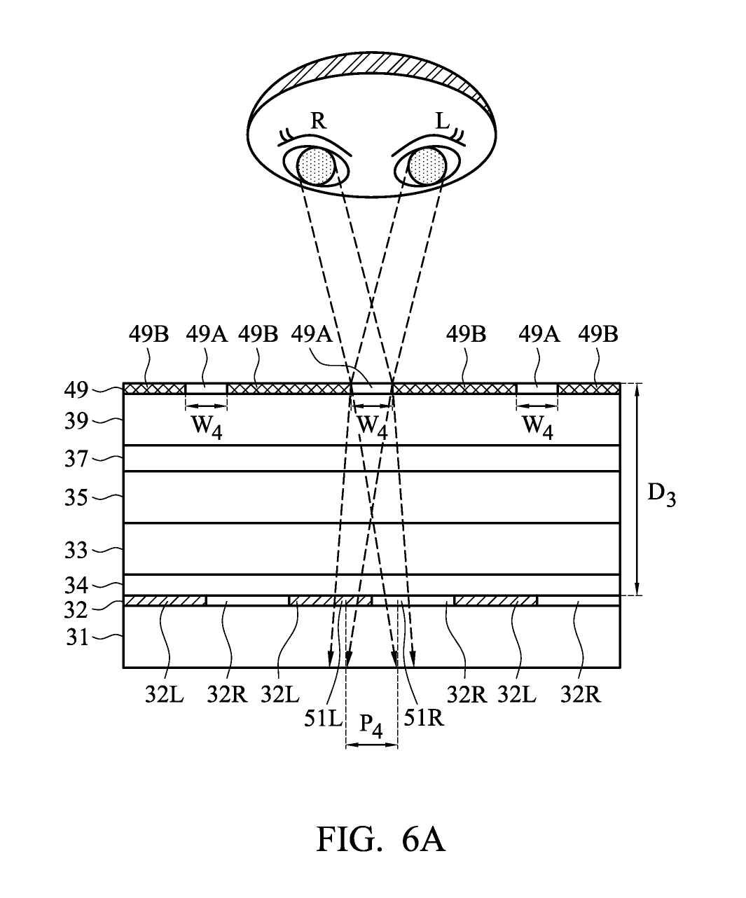

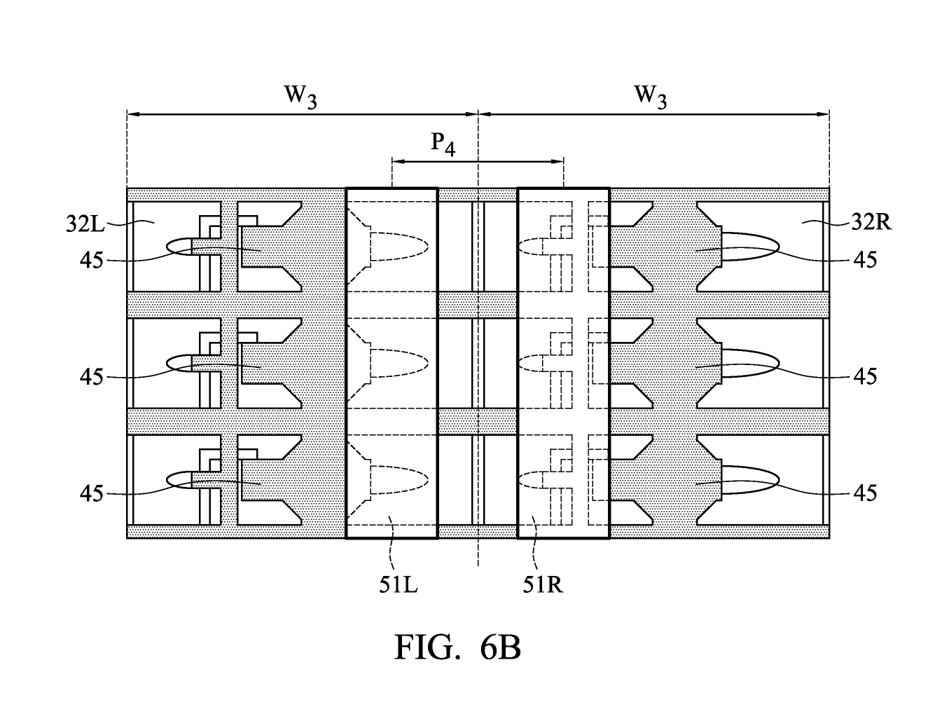

The described design is not only useful for the 3D image display device of the lenticular lens type, but also for that of the 3D barrier type. FIG. 6A shows a barrier type 3D image display device in one embodiment of the disclosure. An image display device, e.g. LCD, includes an array substrate 31, a color filter substrate 33, and a liquid crystal layer 34 disposed therebetween. A plurality of right eye pixels 32R and left eye pixels 32L are alternately arranged to construct a pixel layer 32 on the array substrate 31. A polarizer 35, a glue layer 37, a PET layer 39, and a 3D device such as a 3D barrier 49 are sequentially disposed on the color filter substrate 33. A top of the 3D barrier 49 and a top of the pixel layer 32 have an optical distance in air D₃ therebetween. The 3D barrier 49 includes openings 49A disposed between the light barriers 49B, and the openings 49A substantially align with interfaces of the right eye pixels 32R and left eye pixels 32L. As shown in FIG. 6A, a right eye R of a viewer sees right eye images from the right eye pixels 32R through the openings 49A of the 3D barrier 49, and a left eye L of the viewer sees left eye images from the left eye pixels 32L through the openings 49A of the 3D barrier 49, respectively. The right eye R will see 3D aperture areas 51R on the right eye pixels 32R, and the left eye L will see the other 3D aperture areas 51L on the left eye pixels 32L. The right eye images and the left eye images will be combined in the brain of the viewer to see 3D images. Note that the image display device includes, but is not limited to, the LCD as shown in FIG. 6A. For example, the image display device can be an electronic paper, an electronic reader, electroluminescent display (ELD), organic electroluminescent display (OELD), vacuum fluorescent display (VFD), light emitting diode display (LED), cathode ray tube (CRT), liquid crystal display (LCD), plasma display panel (PDP), digital light processing (DLP) display, liquid crystal on silicon (LCoS), organic light-emitting diode (OLED), surface-conduction electron-emitter display (SED), field emission display (FED), laser TV (Quantum dot laser; Liquid crystal laser), Ferro liquid display (FLD), interferometer modulator display (iMoD), thick-film dielectric electroluminescent (TDEL), quantum dot display (QD-LED), telescopic pixel display (TPD), organic light-emitting transistor (OLET), electrochromic display, laser phosphor display (LPD), or the like. It is understood that the liquid crystal layer 34 can be omitted in other image display devices. Also note that the 3D barrier 49 is not limited to only the fixed type barrier, but also a switchable barrier cell that comprise two glasses, liquid crystal and polarizer. Furthermore, the 3D barrier can be placed under the image display device.

FIG. 6B shows the top view of the right eye pixel and the left eye pixel in FIG. 6A. The right eye pixel 32R includes a top part as a red pixel, a middle part as a green pixel, and a bottom part as a blue pixel. Similarly, the left eye pixel 32L includes a top part as a red pixel, a middle part as a green pixel, and a bottom part as a blue pixel. Each of the red, green, and blue pixels includes a control element 45 such as TFT and/or storage capacitance (Cs) to control the brightness thereof. The right eye pixel 32R and the left eye pixel 32L have a same width W₃. A 3D aperture area 51R center on the right eye pixel 32R and another 3D aperture area 51L center on the left eye pixel 32L have a 3D aperture pitch P₄ therebetween. As shown in FIG. 6B, the width W₃ of the right eye pixel 32R (or the left eye pixel 32L) and the 3D aperture pitch P₄ have a ratio of 100:50.

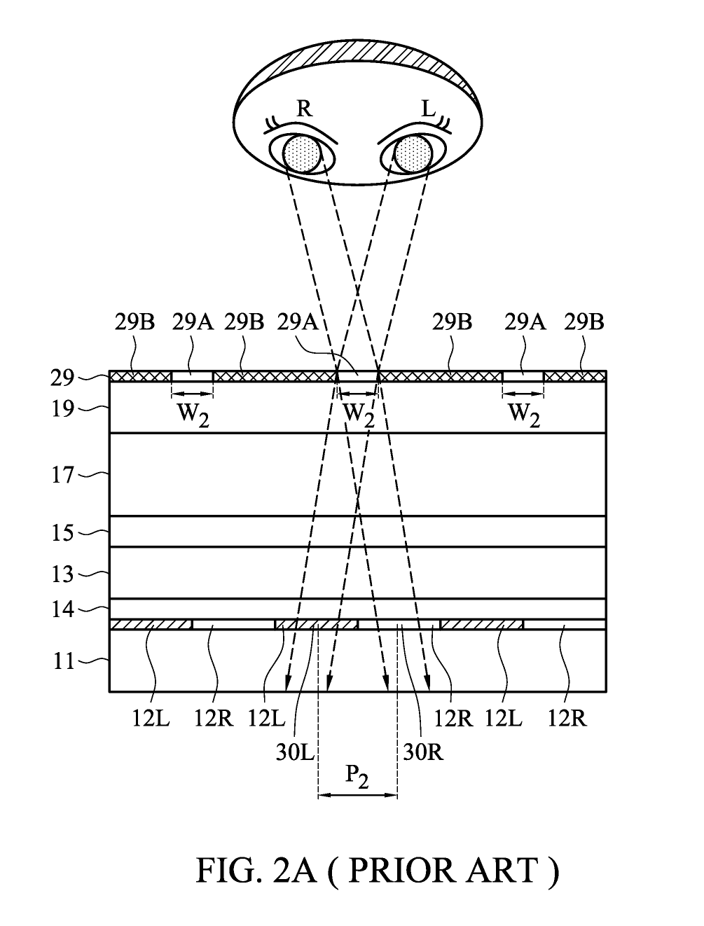

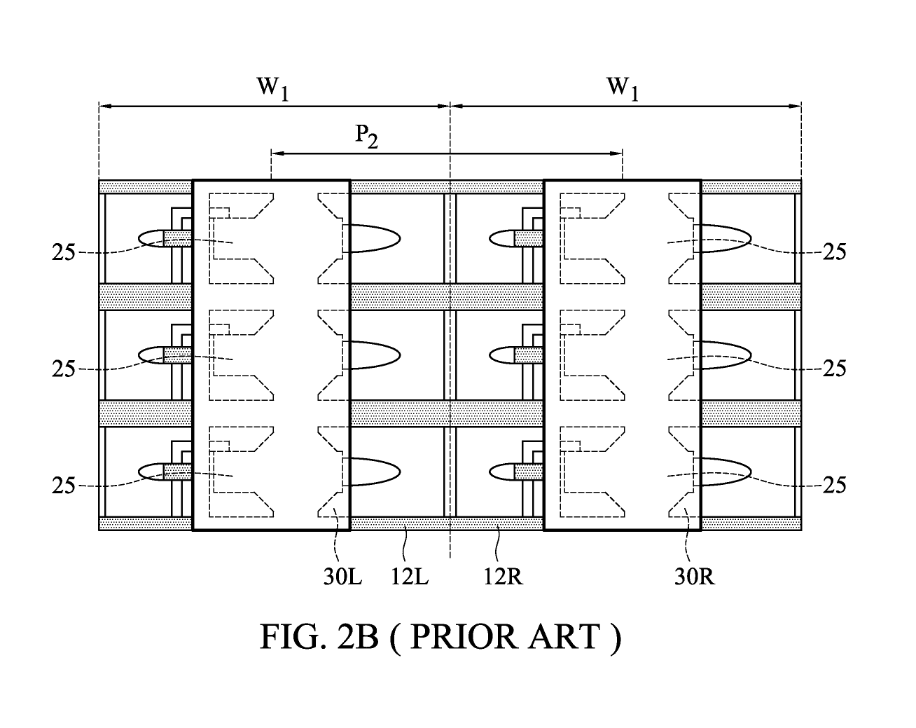

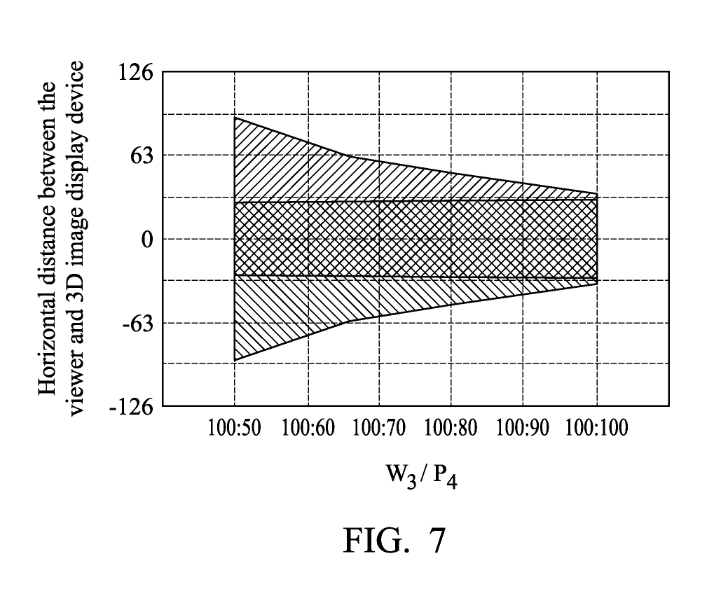

FIG. 7 shows view image types and their region maps of the 3D image display devices having different W₃/P₄ ratios for a viewer in different positions. In FIG. 7, the x-axis means the W₃/P₄ ratio, and the y-axis means the horizontal distance between the viewer and the 3D image display device. The viewer may see 2D right eye images in a right eye image region composed of backslash lines as shown in FIG. 7. 2D left eye images may be seen in a left eye image region composed of the slash lines shown in FIG. 7. 2D images may be seen in a 3D image region composed of grids as shown in FIG. 7. In other positions in FIG. 7, the viewer may see 2D left eye images from the right eye, see 2D right eye images from the left eye, and the 2D right eye images and the 2D left eye images from the unintended eyes will combine in the brain to complete pseudo 3D images. When the W₁/P₂ ratio is 100:100 (e.g. FIG. 2B in related art), the right eye image region almost overlaps the left eye image region. When the W₃/P₄ ratio is 100:50 (e.g. FIG. 6B), the 2D right eye image region and the 2D left eye image region is largely increased. In other words, the 3D image display device with a higher W₃/P₄ ratio will have a larger 2D right eye image region and a larger 2D left eye image region.

Accordingly, when the 3D aperture pitch P₄ is shorter and/or the width W₃ of the right eye pixel 32R (or the left eye pixel 32L) is longer, the pseudo 3D image region will be reduced and the 2D image regions will be increased. In one embodiment, the width W₃ and the 3D aperture pitch P₄ have a ratio of 100:X, where X is smaller than 85. An overly high W₃/P₄ ratio may be difficult in the mass production due to a thinner film and glass requirement, and an overly low W₃/P₄ ratio may not effectively enlarge 2D and 3D image region. Note that the ratio of width W₃ to 3D aperture pitch P₄ can be controlled by the ratio between the width W₃ and the optical distance in air D₃ (see FIG. 6A). The longer optical distance in air D₃, the longer the 3D aperture pitch P₄ may be, and the shorter optical distance in air D₃, the shorter the 3D aperture pitch P₄ may be. In one embodiment, the width W₃ and the distance D₃ have a ratio of 1:Y, where Y is smaller than 4.1. When the width W₃ is a constant, an overly long optical distance in air D₁ may not effectively enlarge 2D and 3D image region, and an overly short optical distance in air D₁ may be difficult in the mass production due to a thinner film and glass requirement.

Accordingly, the conventional pseudo 3D image problem can be solved by the 3D image display device having a suitable ratio W₃/P₃ (for a lenticular lens type) or a suitable ratio W₃/P₄ (for a barrier type) in the disclosure. In other words, the defocused center pitch P₃ (or the 3D aperture pitch P₄) should be shorter than the width W₃ of the right eye pixels and the left eye pixels.

While the disclosure has been described by way of example and in terms of the preferred embodiments, it is to be understood that the disclosure is not limited to the disclosed embodiments. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A 3D image display device, comprising:
an image display device including a pixel layer having a plurality of right eye pixels and a plurality of left eye pixels; and
a 3D device disposed on the image display device,
wherein each of right eye pixels and each of the left eye pixels having a substantially same width,
wherein the 3D device and the pixel layer have an optical distance in air therebetween, and
wherein the width and the optical distance in air have a ratio of 1:Y, where Y is smaller than 4.1.

2. The 3D image display device as claimed in claim 1, wherein the 3D device comprises a lenticular lens layer having a plurality of lenses.

3. The 3D image display device as claimed in claim 2, wherein each of the lenses substantially aligns with the right eye pixel and the left eye pixel.

4. The 3D image display device as claimed in claim 2, wherein a top of the lenses and a top of the pixel layer have the optical distance in air therebetween.

5. The 3D image display device as claimed in claim 1, wherein the 3D device comprises a 3D barrier including an opening.

6. The 3D image display device as claimed in claim 5, wherein the opening substantially aligns with an interface between the right eye pixel and the left eye pixel.

7. The 3D image display device as claimed in claim 5, wherein a top of the 3D barrier and a top of the pixel layer have the optical distance in air therebetween.

8. A method of displaying a 3D image, comprising:
providing the 3D image display device as claimed in claim 1 for a viewer; and
displaying a right eye image from the right eye pixel to a right eye of the viewer through the 3D device, and displaying a left eye image from the left eye pixel to a left eye of the viewer through the 3D device, respectively,
wherein the right eye sees a first area on the right eye pixel, and the left eye sees a second area on the left eye pixel,
wherein the first and second areas have a center pitch therebetween, and
wherein the center pitch is shorter than the right eye and left eye pixel width.

9. The method as claimed in claim 8, wherein the 3D device comprises a lenticular lens layer having a plurality of lenses.

10. The method as claimed in claim 9, wherein each of the lenses substantially aligns with the right eye pixel and the left eye pixel.

11. The method as claimed in claim 9, wherein a top of the lenses and a top of the pixel layer have the optical distance in air therebetween.

12. The method as claimed in claim 8, wherein the 3D device comprises a 3D barrier including an opening.

13. The method as claimed in claim 12, wherein and the opening substantially aligns with an interface between the right eye pixel and the left eye pixel.

14. The method as claimed in claim 12, wherein a top of the 3D barrier and a top of the pixel layer have the optical distance in air therebetween.

15. The method as claimed in claim 8, wherein the right eye and left eye pixel width and the center pitch have a ratio of 100:X, where X is smaller than 85.

16. The method as claimed in claim 8, wherein the right eye and left eye pixel width and the center pitch have a ratio of 100:X, where X is substantially equal to 50.
